(19) United States
(12) Patent Application Publication
(10) Pub. No.: US 2009/0313230 A1
(43) Pub. Date: Dec. 17, 2009

(54) COMPUTING JOB INFORMATION MANAGING DEVICE, TERMINAL, AND COMPUTING JOB INFORMATION MANAGING SYSTEM

(75) Inventor: Koichi SHIMIZU, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/543,563

(22) Filed: Aug. 19, 2009

Related U.S. Application Data
(63) Continuation of application No. PCT/JP2007/000310, filed on Mar. 27, 2007.

(51) Int. Cl. G06F 7/06; G06F 15/16; G06F 15/173; G06F 17/30

(52) U.S. Cl. 707/3; 709/203; 709/224; 707/100; 707/200; 707/E17.014; 707/E17.058

(57) ABSTRACT

A computing job information managing device assigns computing job identification information independent of an existing computing job controller to a computing job. By a matching process, the device associates a job in which a computer executes computation with a job uniquely assigned identification information by the computing job information managing device. A terminal transmits a request to acquire data of the in-progress data of the computation or the result of the computation to the computing job information managing device, thereby acquiring a combination of the address information about a computer needed to use an interface provided by a program being executed in a computer and the number of an available port.

### CROSS-REFERENCE TO RELATED APPLICATION

This application is a continuation application of International PCT Application No. PCT/JP2007/000310, filed on Mar. 27, 2007, the entire contents of which are incorporated herein by reference.

### FIELD

The present invention relates to a computing job information managing device for managing information by allocating identification information to a computing job independent of an existing computing job control server device, a client terminal of a user communicating data with the computing job information managing device, and a computing job information managing system including the device and the terminal.

### BACKGROUND

In a numerical analysis field, a necessary physical quantity in a temperature distribution etc. is obtained on a model by, for example, executing computation with a specified boundary condition and model.

Conventionally, when in-progress data of computation is to be checked, a computing job information managing system is first referenced, a computer to which a user input computing job has been allocated is checked, and then the computer is logged in, and the log file generated by a computing program is opened by a text editor, thereby confirming the in-progress computation data. However, the problem is that the operation is a time and labor consuming process.

Recently, a computing time has been shortened by performing parallel computation with a plurality of CPUs (central processing units) loaded into a computer.

However, since a computer is loaded with a plurality of CPUs, the computer executes a plurality of computing jobs. In this case, operations of reading data using the interface of an executing program simultaneously occur in a computer among a plurality of users. That is, there is the possibility of illegal access.

As a technique of performing parallel computation, for example, the patent document 1 discloses a parallel processing system to which a plurality of clients are connected to a centralized server. In this system, a client can be a submitter (source of a request) and a client that processes a work-load. In addition, a centralized server performs work-load balancing, and starts and completes a job. Other commands and status information are directly communicated among a plurality of clients who process the work-load without a centralized server.

Patent Document 1: Japanese Laid-open Patent Publication No. 2005-004740 “Peer-to-Peer Job Monitor and Control in Grid Computing System”

### SUMMARY

The computing job information managing device according to the first aspect of the present invention manages computing job information using a computing job controller and a plurality of computers allocated computing jobs by the computing job controller. The computing job information managing device includes: an identification information assignment unit for assigning computing job identification information independent of the computing job controller to an input computing job upon receipt of a notification that a terminal has input the computing job to the computing job controller together with user identification information and identification information about a computation executing program from a terminal; a computing job information storage unit for storing a record in which at least the computing job identification information is associated with the user identification information; a matching unit for performing a matching process using user identification information and identification information about a computation executing program upon receipt of the state change information about the computing job from a computer assigned a computing job together with user identification information and identification information about a computation executing program; and a computing job identification information access control unit for writing received state change information to a related item of a record of the computing job information storage unit associated with the received state change information by the matching process.

The computing job information managing device according to the second aspect of the present invention is based on the first aspect above, and further includes: an available port determination unit for determining whether or not there is an available port for a computer executing computation upon receipt of a request to acquire in-progress data of the computation or data of a result of the computation; and a computer information transmission unit for transmitting to a terminal a combination of address information about a computer that performs computation and the number of available ports when there are available ports.

The computing job information managing device according to the third aspect of the present invention is based on the first aspect further includes: a second matching unit for performing a matching process using user identification information and identification information about a computation executing program upon receipt of a feature value as a part of data output by a computation executing program together with user identification information and identification information about a computation executing program as a feature value entry notification; a second computing job identification information access control unit for writing a received feature value to a related item of a record of the computing job information storage unit associated with the received feature value by the matching process; a collective job completion determination unit for determining whether or not all computing jobs belonging to a collective job have been completed when the feature value entry notification is issued from a computing job belonging to the collective job; a statistical analysis execution unit for executing a statistical analysis using each feature value of a computing job belonging to the collective job when it is determined that all computing jobs belonging to the collective job have been completed; and an analysis result transmission unit for transmitting an analysis result to a terminal.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed

### BRIEF DESCRIPTION OF DRAWINGS

FIG. 1 is a block diagram of the configuration of the computing job information managing system common to each embodiment of the present invention;

FIG. 2 is a flowchart of the process from specifying to inputting computing job information common to each embodiment of the present invention;

FIG. 3 is a job type selection screen;

FIG. 4 is a collective job selection screen;

FIG. 5 is a collective job input screen;

FIG. 6 is a single job selection screen;

FIG. 7 is a single job input screen;

FIG. 8 illustrates the data structure of a job input notification from a client device to a DB server device;

FIG. 9 illustrates the data structure of a state change notification from a computer to a DB server device;

FIG. 10 is a block diagram of the configuration of the DB server device according to the first embodiment of the present invention;

FIG. 11 illustrates the data structure of the job information storage unit;

FIG. 12 illustrates the sequence of the process from inputting a common job to starting computation common to each embodiment;

FIG. 13 is a flowchart of the job information generating process performed by a DB server device upon receipt of a job input notification;

FIG. 14 is a flowchart of the job information changing process upon receipt of a state change notification;

FIG. 15 illustrates the data structure of the computer information storage unit;

FIG. 16 illustrates the data structure of a request of in-progress computation data from a client computer to a DB server device;

FIG. 17 illustrates the sequence of the process from a visualize request to the reception of in-progress computation data needed for visualization according to the first embodiment;

FIG. 18 is a flowchart of the reply information generating process performed by the DB server device when a visualize request is received according to the first embodiment;

FIG. 19 illustrates the data structure of a feature value entry notification from a computer to a DB server device;

FIG. 20 is a block diagram of the configuration of the DB server device according to the second embodiment of the present invention;

FIG. 21 illustrates the data structure of the collective job unique information storage unit;

FIG. 22 illustrates the sequence of the process after completing the computation in the second embodiment; and

FIG. 23 is a flowchart of the feature value entry/statistical analysis executing process performed by the DB server device when a feature value entry notification is received according to the second embodiment.

### DESCRIPTION OF EMBODIMENTS

The embodiments of the present invention are described below in detail with reference to the attached drawings.

In each embodiment of the present invention, a distribution memory system is configured by a cluster forming a parallel computer by connecting a computer over a network. An interface for parallelism can be, for example, an MPI (message passing interface).

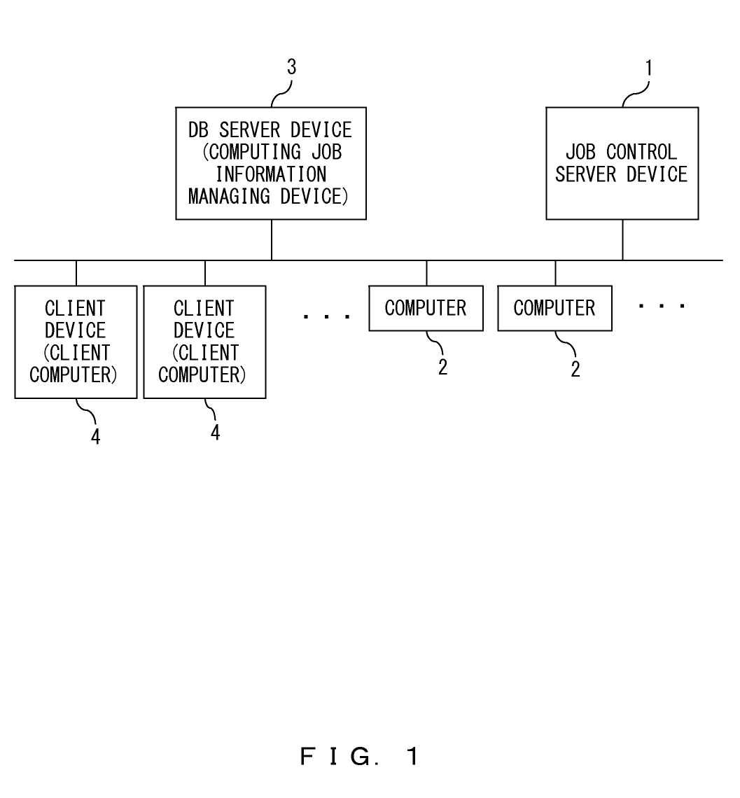

FIG. 1 is a block diagram of the configuration of the computing job information managing system common to each embodiment of the present invention. As illustrated in FIG. 1, the computing job information managing system includes a job control server device 1, a plurality of computers 2, a computing job information managing device 3 (also referred to as a “database server device” and a “DB server device”), a plurality of client devices 4 (also referred to as a “client computer”). These components are connected to one another over a LAN (local area network).

The client device 4 is a terminal device operated by a user. The user generates data specifying an analysis condition and a model of a computation program for a structure analysis etc. using a UI (user interface) unit (not illustrated in the attached drawings) of the client device 4, issues a job input notification to the computing job information managing device 3 described later, and transmits a visualize request for all jobs input by the user to the computing job information managing device 3.

The job control server device 1 assigns identification information (JOB_ID) to the job input from the client device 4, and allocates the job to one or more computers 2. The JOB_ID allocated to the job functions as the information identifying the job and shared by the job control server device 1 and the (one or more) computers executing the job.

In each of the embodiments of the present invention, a plurality of computers are connected over a LAN to configure a parallel computer so that one job can be processed in parallel. One of a plurality of computers acts as a head node collecting input data and output data of the job. There can be a node storing input data and another node storing output data.

The job control server device 1 and the computer 2 are provided for an existing system.

The computing job information managing device 3 assigns a JOB_ID independent of the JOB_ID assigned by the job control server device 1 to the job input by a user to the job control server device 1 through the client device 4. The computing job information managing device 3 is described later in detail.

In the second embodiment described later, a (collective) JOB_ID is assigned to a plurality of jobs. As distinguished from the collective JOB_ID, a job is defined as a single job in the second embodiment, and an ID assigned to one job is referred to as a single JOB_ID.

In the first embodiment, a user issued a visualize request through the client device 4 to visualize the in-progress data of the computation of all jobs input from the client device 4, and display the data on the display of the client device 4.

In the second embodiment of the present invention, when a plurality of jobs are executed by a user through the client device 4, a part of the result of the computation of each job is used as a feature value, and the notification of the feature value is transmitted from each computer 2 to the computing job information managing device 3 after the completion of the computation, thereby performing the statistical analysis on the result of the computation of the plurality of jobs.

In any embodiment, it is preferable for a user to specify a combination of analysis condition data and model data as input data for the executing program designated by an execute command name (also referred to as a “executing program ID”) using the UI unit of the client device 4. The number of combinations of analysis condition data and model data specified for an executing program is one for a single job, and a plurality of combinations for a collective job.

Normally, the analysis condition data and model data are stored in a file, they are called an analysis condition file and a model file respectively.

A model file (model data) is a file (data) storing the information about the shape of a substance simulated in an executing program. An analysis condition file (analysis condition data) is a file (data) specifying the amount (temperature distribution, stress, etc.) computed by an executing program. The analysis condition file stores a user ID.

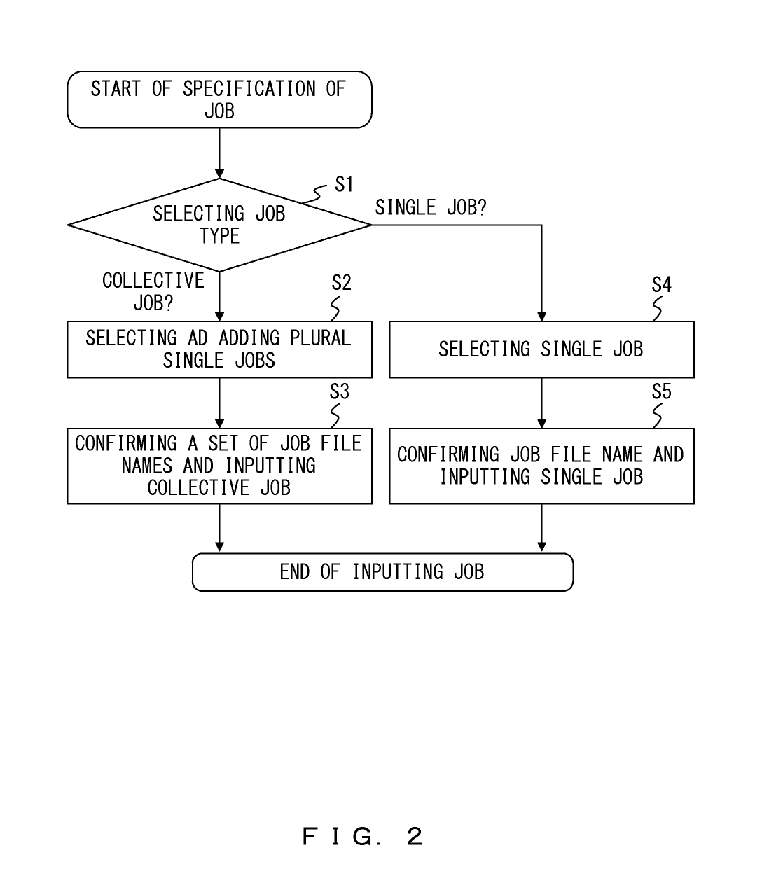

FIG. 2 is a flowchart of the process from specifying to inputting a job executed through a part of the UI unit of the client device 4. Prior to the processing of the flowchart, an executing program is assumed to have been specified. The processing is to associate the specified executing program with an input file.

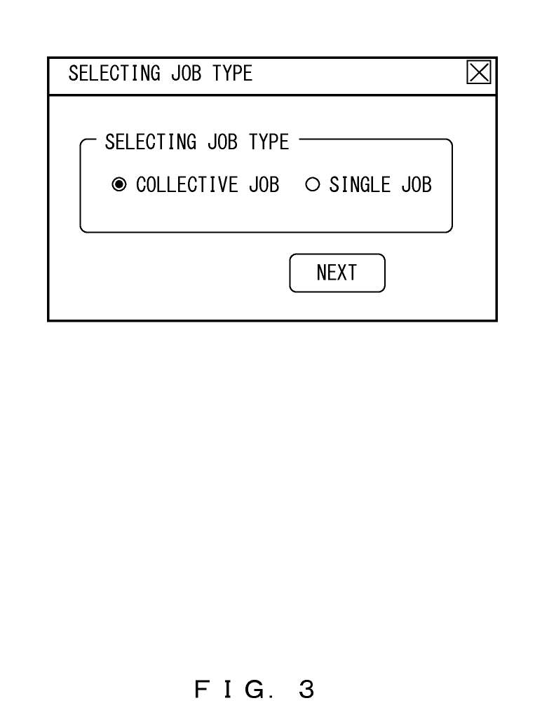

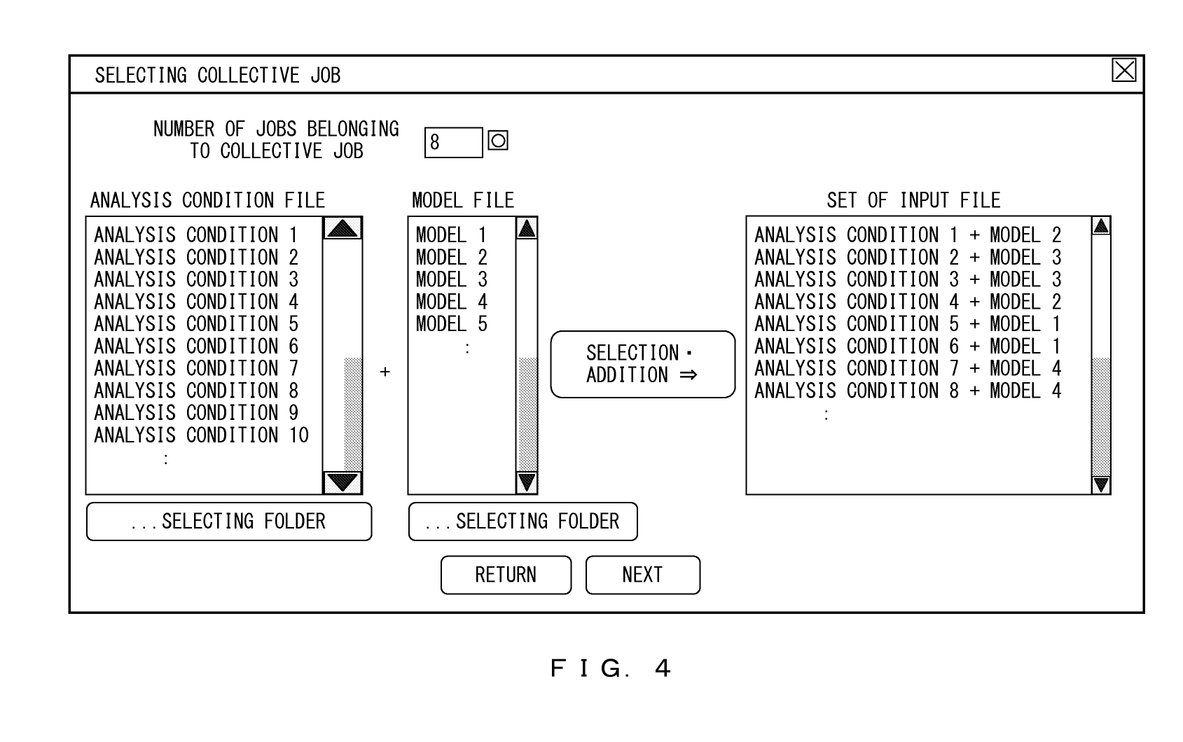

In FIG. 2, first in step S1, the selection screen as illustrated in FIG. 3 is displayed on the display unit of the client device 4, and a job type is selected on the selection screen. In this case, a collective job or a single job is selected. If the “next” button on the selection screen in FIG. 3 is pressed with a collective job selected in step S1, then the selection screen as illustrated in FIG. 4 is displayed on the display unit of the client device 4, a combination of the number of jobs belonging to a collective job, the number of analysis condition files specified for the number of jobs, and a model file are selected on the selection screen in step S2. As a result, the collective job is specified. A resultant combination of an analysis condition file and a model file is displayed on the list box of a set of input file.

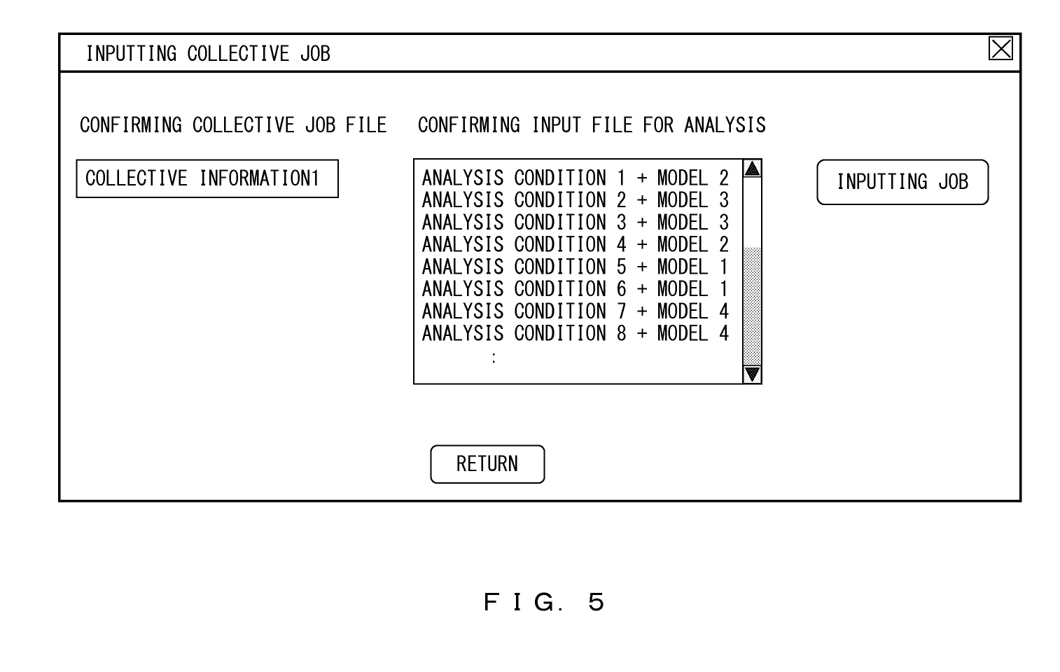

If a combination of the number of jobs belonging to the collective job, the analysis condition file, and the model file is completely specified in step S2, and the “next” button on the selection screen in FIG. 4 is pressed, then the input screen as illustrated in FIG. 5 is displayed for confirmation before input to the display unit of the client device 4 in step S3. If the “job input” button is pressed on the input screen, the collective job specified on the selection screen in FIG. 4 is input to the job control server device 1, and the notification that the input is performed to the job control server device 1 is transmitted to the computing job information managing device 3, thereby terminating the series of processes.

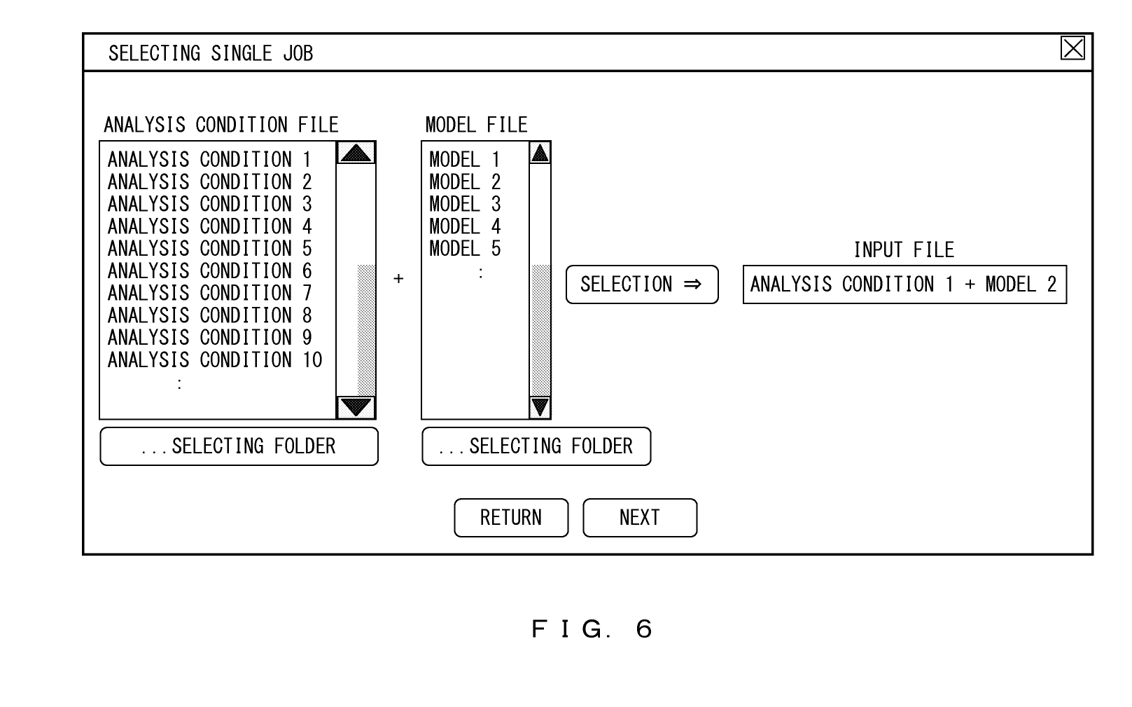

On the other hand, if the “next” button on the selection screen in FIG. 3 is pressed with the single job selected in step S1, then the selection screen as illustrated in FIG. 6 is displayed on the display unit of the client device 4, a combination of an analysis condition file belonging to a single job and a model file is selected on the selection screen in step S4, thereby specifying a single job. The resultant combination of analysis condition file and model file is displayed in the field corresponding to the header “input file”.

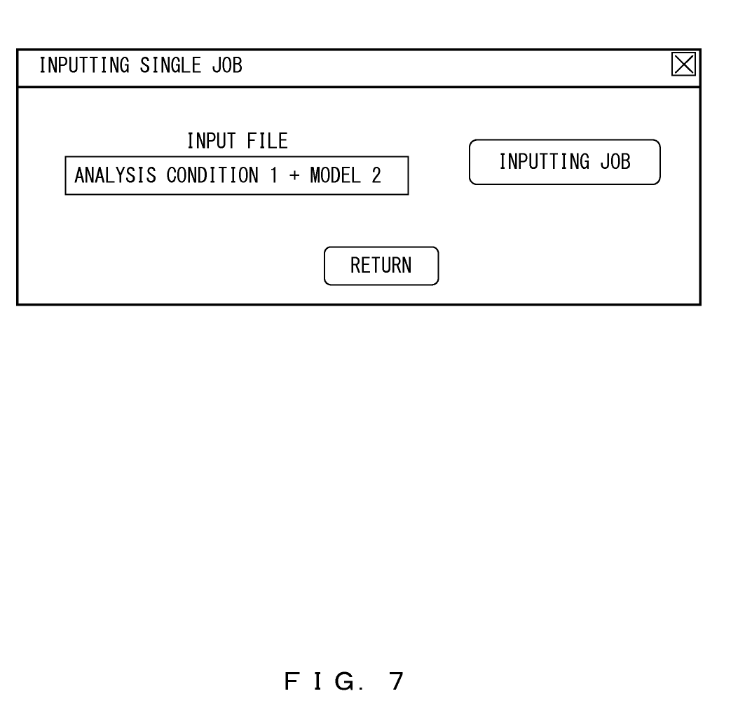

In step S4, when a combination of an analysis condition file belonging to a single job and a model file is completely specified and the “next” button on the selection screen in FIG. 6 is pressed, then the input screen as illustrated in FIG. 7 is displayed for confirmation before the input to the display unit of the client device 4 in step S5. When the “job input” button is pressed on the input screen, the single job specified on the selection screen in FIG. 6 is input to the job control server device 1, and a notification that the input to the job control server device 1 has been performed is issued to the computing job information managing device 3, thereby terminating the series of processes.

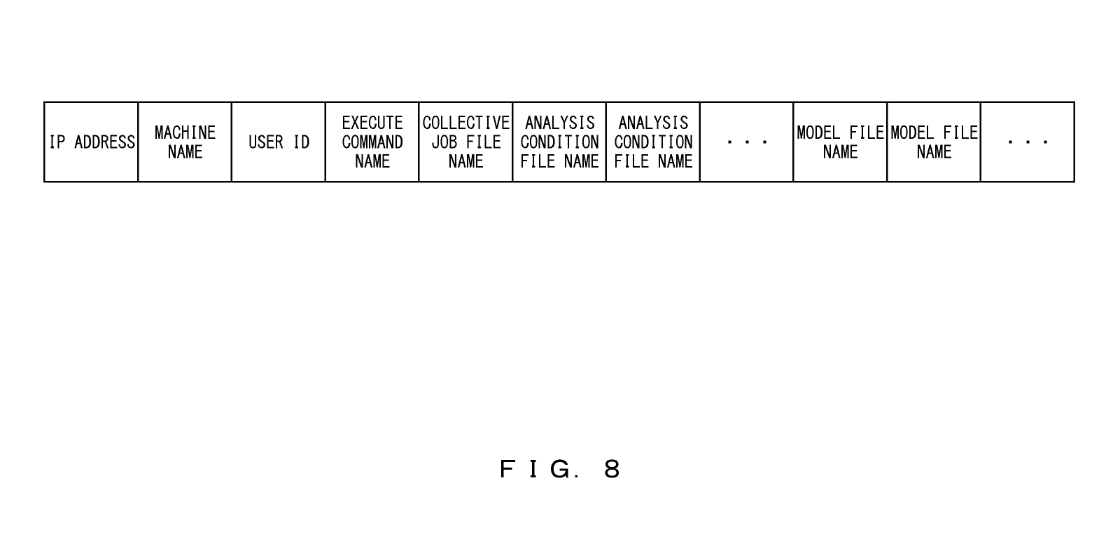

FIG. 8 illustrates the data structure of the job input notification from the client device to the DB server device. The job input notification is transmitted from the client device 4 to the computing job information managing device 3 when the “job input” button is pressed in steps S3 and S5.

As illustrated in FIG. 8, the notification of the input of the job includes the items of the IP address of the client device 4 as a source, the machine name of the client device 4, the user ID of the user logged into the client device 4 as the source, the execute command name specifying an executing program, the collective job file name for which a value significant only when the input job is a collective job is set, the analysis condition file name specifying analysis condition data for the number of single jobs, and the model file name specifying model data for the number of single jobs.

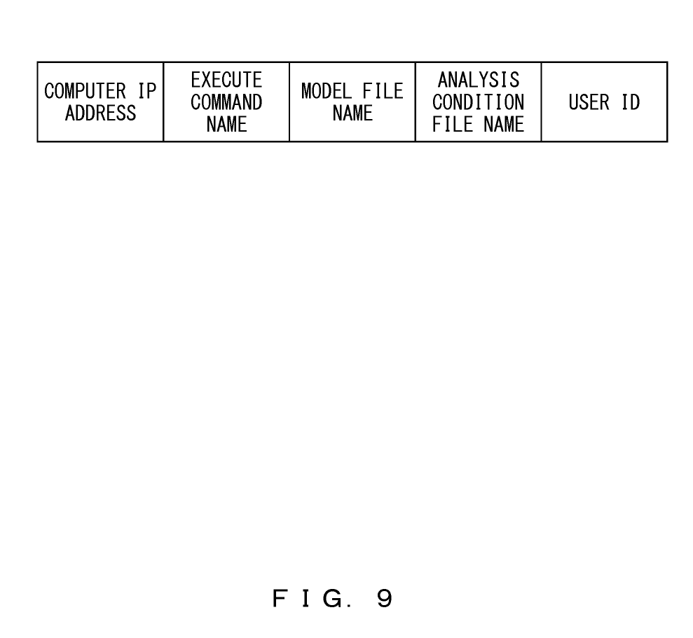

FIG. 9 illustrates the data structure of the state change notification from a computer to a DB server device. The state change notification is transmitted from the computer 2 to the computing job information managing device 3 when the computer 2 allocated a job by the job control server device 1 starts the computation for the job or when the computation of the job is terminated.

As illustrated in FIG. 9, the state change notification includes the items of the IP address of the computing job information managing device 3 as a source, the execute command name identifying the program that has started or terminated the computation, the model file name or the analysis condition file name associated with the execute command, and the user ID of the user who has input the job.

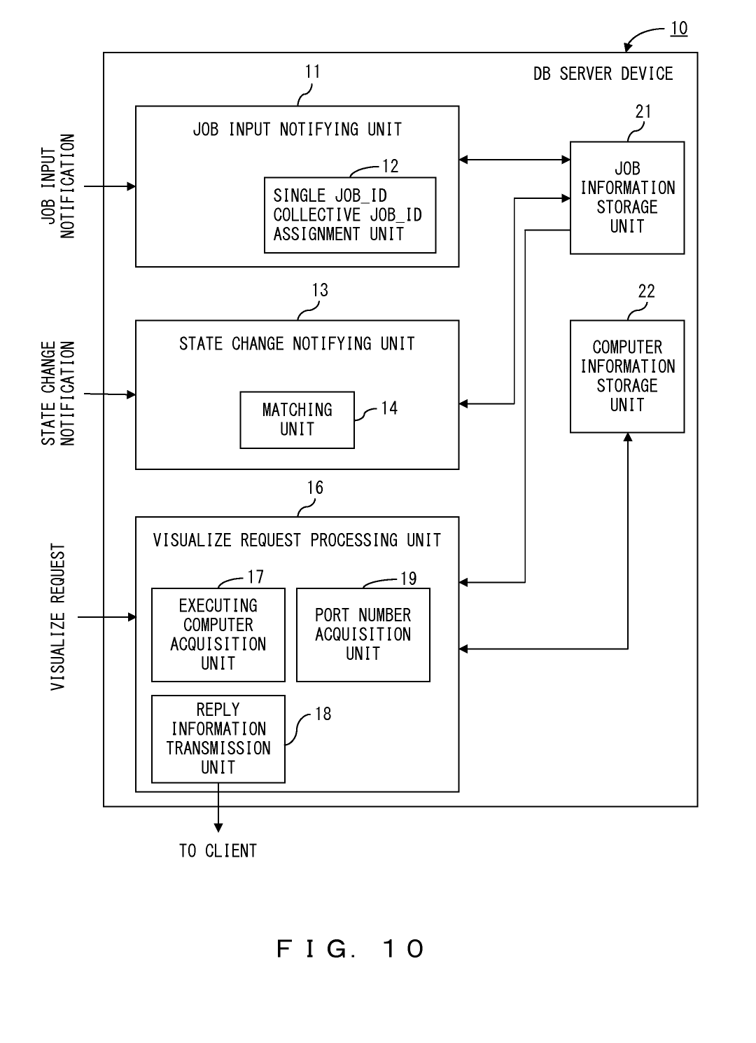

FIG. 10 is a block diagram of the configuration of the DB server device according to the first embodiment of the present invention.

As illustrated in FIG. 10, a DB server device 10 includes: a job input notifying unit 11 for processing a job input notification received from a client device; a state change notifying unit 13 for processing a state change notification received from a computer; a visualize request processing unit 16 for processing a visualize request received from a client device; a job information storage unit 21 storing the JOB_ID assigned to the job independent of the job control server device 1 as associated with each item of the JOB_ID; and a computer information storage unit 22 storing a computer associated with the port numbers for which the computer permits a connection.

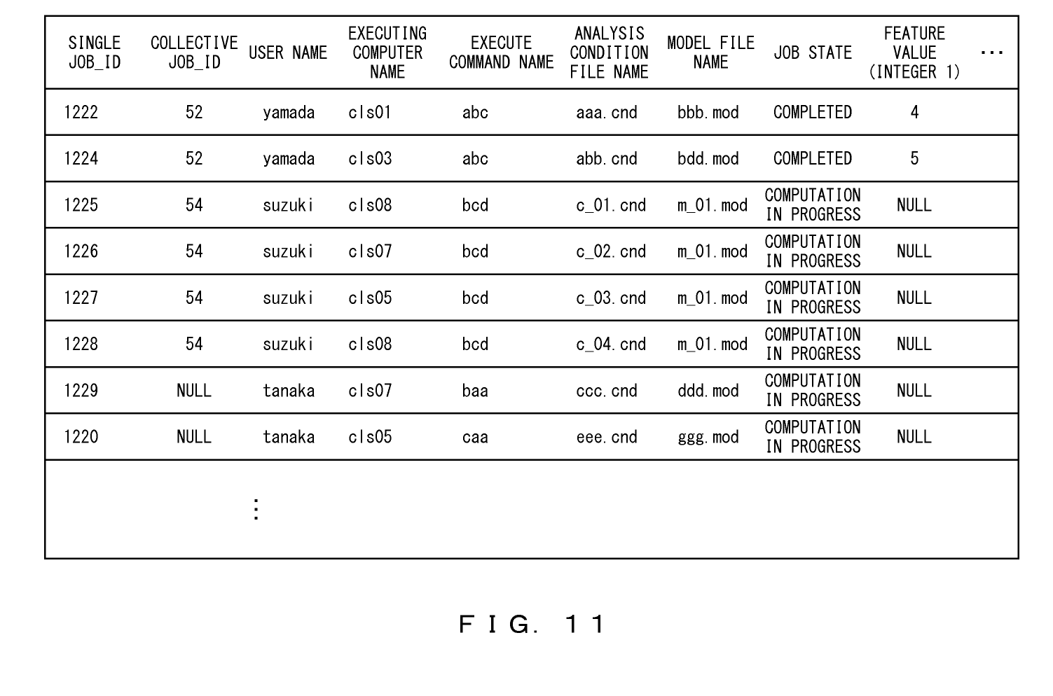

FIG. 11 illustrates the data structure of the job information storage unit 21 illustrated in FIG. 10.

As illustrated in FIG. 11, the job information storage unit 21 includes the items of a “single JOB_ID”, a “collective JOB_ID”, a “user name”, an “executing computer name”, an “execute command name”, an “analysis condition file name”, a “model file name”, a “job state”, a “feature value (integer) 1”, . . . , “feature value (double-precision) 1”, . . . . The screen processing unit (not illustrated in the attached drawings) of the DB server device 10 displays the screen as illustrated in FIG. 11 on the browser of the client device. Therefore, the job information storage unit 21 stores the items of “user name” and “executing computer name” familiar with a user.

On the other hand, the computer can recognize only the user ID set in the analysis condition file. Therefore, the DB server device 10 converts the user ID included in the information received from the computer into a user name using the storage unit (not illustrated in the attached drawings) in which the user name is associated with the user ID. In addition, the DB server device 10 also includes a storage unit in which a computer name is associated with a computer IP address.

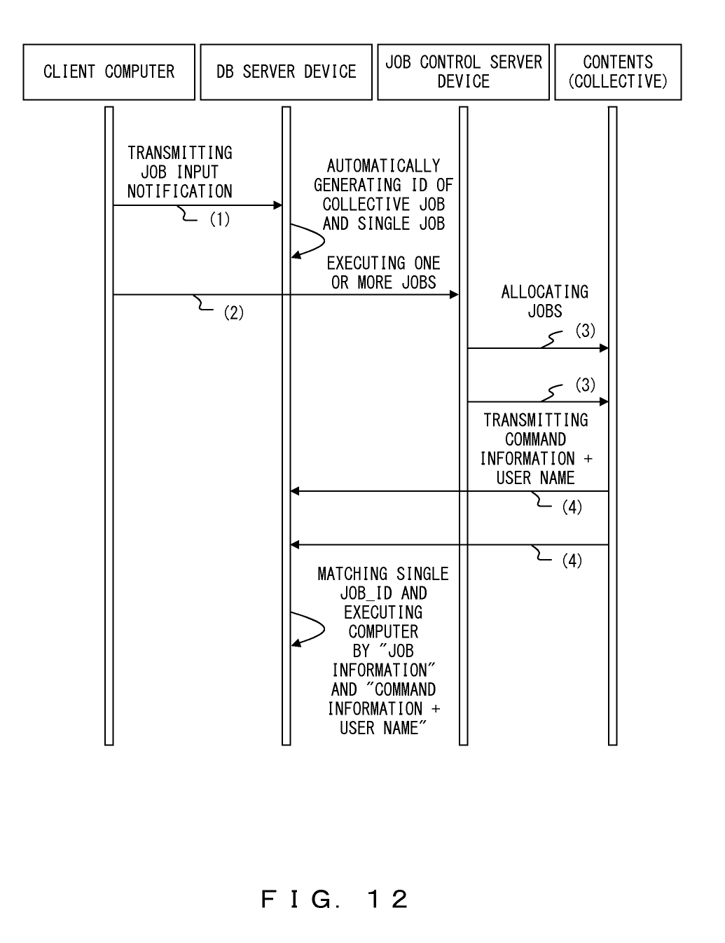

FIG. 12 is a chart of the sequence of the process from inputting a job to starting computation. The sequence is common between the first and second embodiments.

In FIG. 12, a job input notification is transmitted from the client computer (client device) to the DB server device in (1). The job input notification has the data structure as illustrated in FIG. 8.

Upon receipt of the job input notification, the DB server device assigns a single JOB_ID to the single job by automatic numbering when the input job is a single job. When the input job is a collective job, it assigns a collective JOB_ID to the collective job by automatic numbering, and also assigns a single JOB_ID to all single jobs belonging to the collective job by automatic numbering.

In (2) illustrated in FIG. 12, an execute instruction for one or more jobs, that is, the input of jobs, is performed from the client computer to the job control server device. Practically, with the input of the jobs, a job input notification is issued to the DB server device.

The job control server device to which one or more jobs are input assigns a JOB_ID shared between the job control server device and the computer to each of the input jobs, and allocates each of the input jobs to each computer in (3).

When the execution of the allocated job is started or terminated, each computer uses the function responsive to the start and end of the execution, and issues a state change notification to the DB server device in (4). The state change notification has the data structure as illustrated in FIG. 9, and includes command information (execute command name+analysis condition file name+model file name) and a user name.

Upon receipt of the state change notification, the DB server device associates the state change notification with any of the job assigned an ID by the device by performing a matching process by referring to the value of each item included in the state change notification.

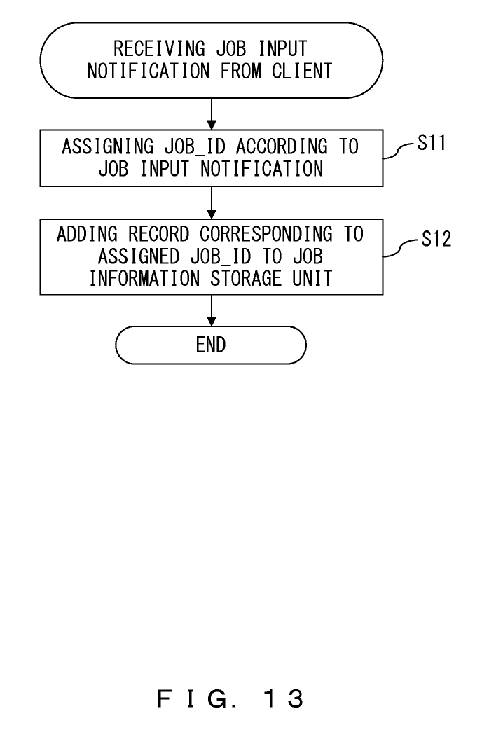

FIG. 13 is a flowchart of the job information generating process performed by the DB server device when a job input notification is received.

In FIG. 13, first in step S11, the job input notifying unit 11 illustrated in FIG. 10 refers to a received job input notification, and assigns identification information (ID) to the input job.

The job input notification has the data structure as illustrated in FIG. 8. The job input notifying unit 11 refers to the collective job file name in the data, thereby determining whether the input job is a collective job or a single job depending on whether or not a valid value is set in the collective job file name.

If it is determined that the input job is a single job, then the job input notifying unit 11 activates the single/collective JOB_ID assignment unit 12 and notifies it of the single job, and acquires a single JOB_ID.

If it is determined that the input job is a collective job, then the job input notifying unit 11 activates the single/collective JOB_ID assignment unit 12 and notifies it of the number of the analysis condition file names or the model file names included in FIG. 8, that is, the number of jobs included in the collective job, and the information that the job is a collective job, thereby acquiring one collective JOB_ID and the single JOB_ID for the number of jobs by automatic numbering.

In the next step S12, the job input notifying unit 11 generates a template of 1-line data of the job information storage unit illustrated in FIG. 11 for each acquired single JOB_ID, writes a value to the item of a single JOB_ID (collective JOB_ID), a user name, an execute command name, an analysis condition file name, and a model file name to generate a record, and adds the record to the job information storage unit illustrated in FIG. 11.

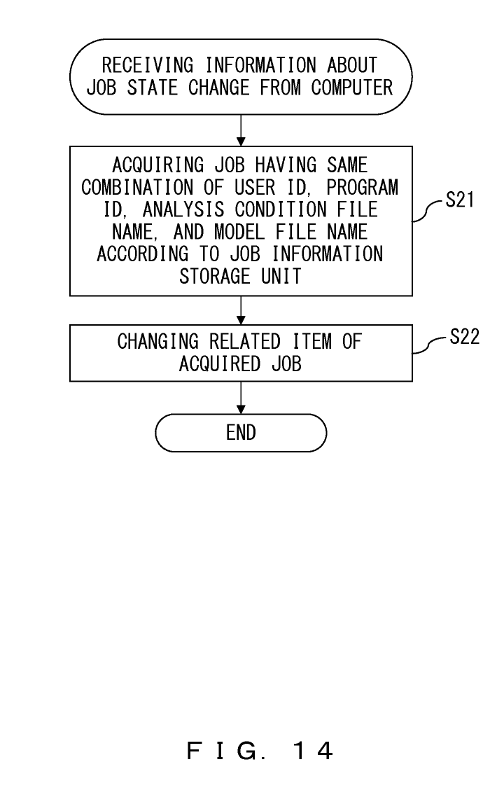

FIG. 14 is a flowchart of the job information changing process performed by the DB server device when a state change notification is received.

In FIG. 14, first in step S21, the state change notifying unit 13 illustrated in FIG. 10 associates (matches) the received state change notification with the job information stored in the job information storage unit.

The state change notification has the data structure as illustrated in FIG. 9. The state change notifying unit 13 activates a matching unit 14 to search the job information storage unit 21 and acquire the row (record) of a single job having the same combination of the execute command name, the model file name, the analysis condition file name, and the user ID as the received state change notification.

Then, the state change notifying unit 13 writes the value included in the state change notification to the item of the executing computer IP address in the acquired record in step S22, writes “during computation” to the item of the job state to change the record, and writes the changed record to the job information storage unit 21.

In the first embodiment, the client computer issues a visualize request to the DB server device, thereby acquiring the information about the computer executing the computation of all jobs executed by a user through the client computer. Then, using the first interface (request to acquire in-progress computation data) provided by the executing program, the client computer accesses the array of the executing programs and acquires the in-progress data of the computation at the client computer side.

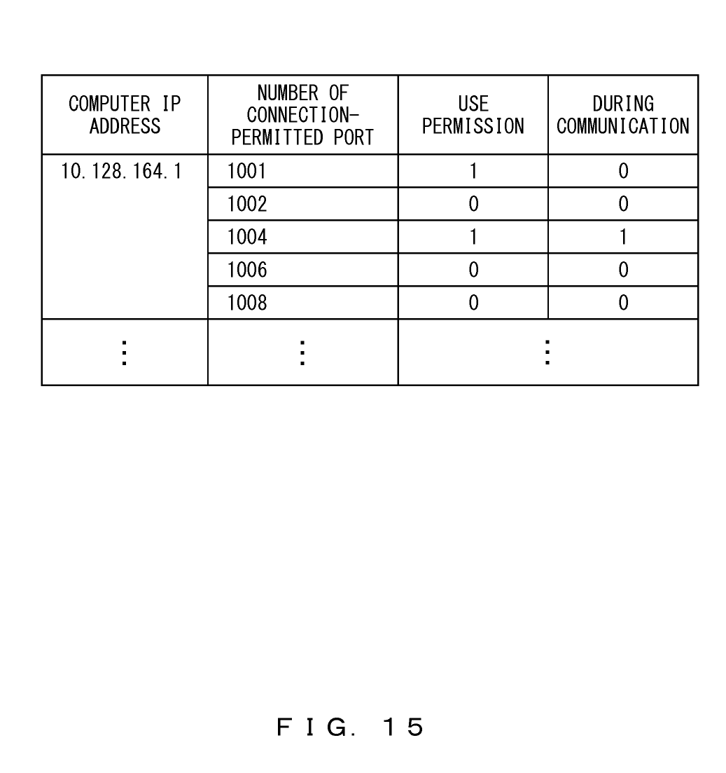

FIG. 15 illustrates the data structure of the computer information storage unit 22 illustrated in FIG. 10.

As illustrated in FIG. 15, the computer information storage unit 22 includes each of the items “computer IP address”, “number of connect permitted port”, “use permission”, and “during communication”.

The “use permission” is flag information (1 indicating “permitted”, and 0 indicating “not permitted (port unused)”) indicating whether or not the client computer is permitted to use a port. The “during communication” is flag information (1 indicating “during communication”, and 0 indicating “not in communication”) indicating whether or not the client computer permitted to use a port is communicating with the computer having the port.

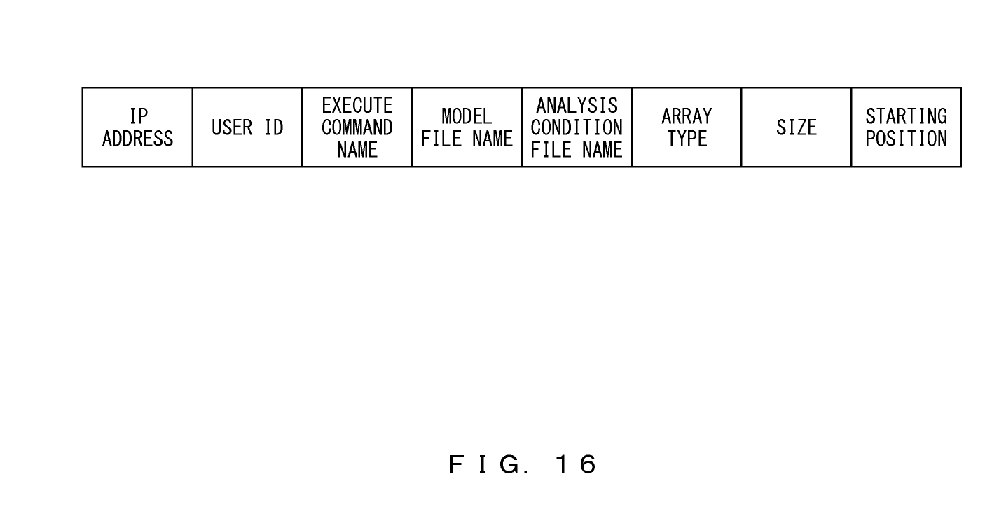

FIG. 16 illustrates the data structure of a request to acquire in-progress computation data to be issued from the client computer to the DB server device.

As illustrated in FIG. 16, the request to acquire in-progress computation data includes each of the items “IP address (of the client computer)”, “user ID”, “execute command name”, “model file name”, “analysis condition file name”, “type of array”, “size”, and “starting position”.

The “type of array” is flag information (0 indicating the array storing data of a node, and 1 indicating the array storing data of a cell center) for determining which array storing a specific value on the cell set on an object to be simulated is to be acquired from the executing program. The “size” is an item indicating what size of data is to be acquired from the array. The “starting position” is an item for determining the starting position in the array when the data determined for the item of the “size” is acquired.

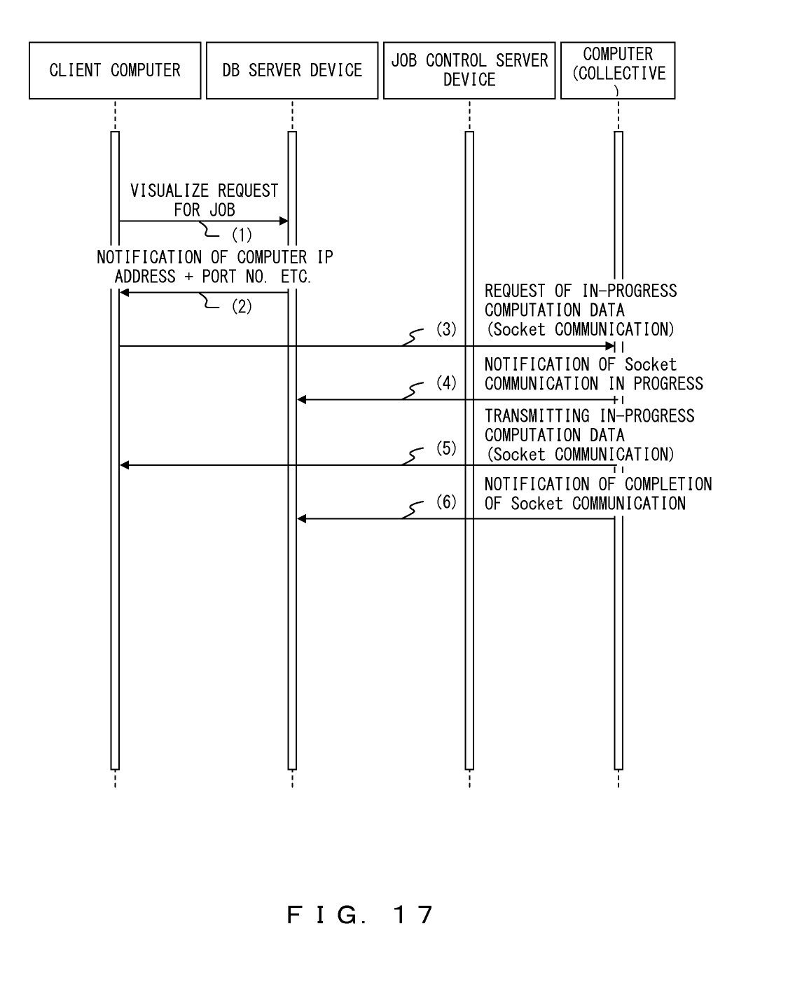

FIG. 17 is a chart of the sequence of the process from the visualize request to the reception of the in-progress computation data needed for visualization.

In FIG. 17, first in (1), the visualize request for all jobs being performed through the client computer to which the user has logged or another client computer to which the user previously logged, or completely performed is issued from the client computer to the DB server device.

The DB server device receives the visualize request, generates the information about the computer that has executed computation on all jobs of the user, and transmits the information as reply information (2) to the client computer.

That is, if there is an available port for a computer that has executed computation, then a notification of a combination of the IP address of the computer and the number of the available port is transmitted to the client computer. If there is no available port for the computer, then a notification of no available port is transmitted to the client computer.

At the client computer that has received the combination of the IP address of the computer and the number of the available port from the DB server device, a “visualized data acquisition” button (not illustrated in the attached drawings) in (3), thereby transmitting a request to acquire in-progress computation data (socket communication) to an executing program on the computer having the IP address in (3). The request to acquire the in-progress computation data has the data structure as illustrated in FIG. 16.

The request to acquire the in-progress computation data is made through the first interface provided by the executing program as described above, but the executing program also has the second interface for answering the request to acquire data to a port and the third interface for answering upon completion of the data transfer from the port.

In (4), a notification that a socket communication is being performed is transmitted from the computer that has received the request to acquire in-progress computation data to the DB server device using the second interface. Upon receipt of the notification, the DB server device changes the value of the item “during communication” of the computer of the computer information storage unit illustrated in FIG. 15 from “0” or “1”.

In addition, the executing program of the computer that has received the request to acquire the in-progress computation data transmits the data in the range of the specified array to the client computer in (5).

When the transmission of the data is completed, the notification that the socket communication has been completed is transmitted from the executing program of the computer that has received the request to acquire in-progress computation data to the DB server device using the third interface in (6). Upon receipt of the notification, the DB server device changes the values of the items “use permission” and “during communication” of the computer of the computer information storage unit illustrated in FIG. 15 from “1” to “0”.

The client computer that has received the in-progress computation data performs the visualizing process using the in-progress computation data. For example, when only two variables have changed in the in-progress computation data, the two variables are set on the axes of abscissas and ordinates to perform the two-dimensional visualization and display a processing result on the display unit of the client computer. When only three variables have changed in the in-progress computation data, the three variables are set on the X, Y, and Z axis directions orthogonal to one another to perform the three-dimensional visualization and display a processing result on the display unit of the client computer.

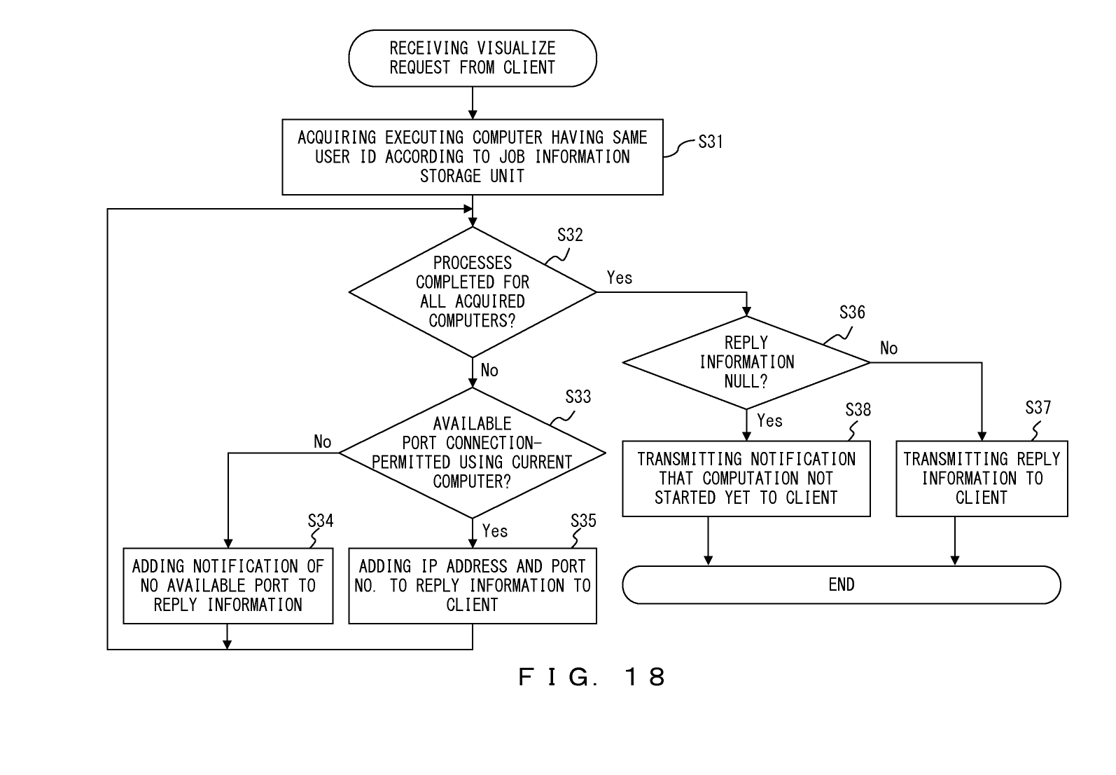

FIG. 18 is a flowchart of the reply information generating process performed by the DB server device when the visualize request is received according to the first embodiment.

In FIG. 18, first in step S31, an executing computer acquisition unit 17 of the visualize request processing unit 16 illustrated in FIG. 10 acquires the job information stored in the job information storage unit 21, and acquired is a list of the values set in the item of the executing computer ID in the row of the job information having the same user ID as the received visualize request in the acquired job information. The visualize request has the items of an IP address of the client computer (client device) and a user ID.

In the next step S32, the visualize request processing unit 16 determines whether or not the process has been completed on all computers in the acquired list. If it is determined that the process has not been completed, then a port number acquisition unit 19 acquires the information (items of a computer IP address, a number of connection-permitted port, a use permission, and during communication) about the current computer from the computer information storage unit 22. Then, the visualize request processing unit 16 determines whether or not there is a connection-permitted port in the current computer, that is, whether or not there is a port in which the value of the item “use permission” is set to “0” indicating that the value is not permitted.

When there are connection-permitted ports, for example, a port having the smallest port number in those ports can be connected in step S35. In the example illustrated in FIG. 15, the value of the item “use permission” is changed from “0” to “1” for the port number “1002”. Then, the visualize request processing unit 16 adds a combination of the IP address of the computer and the port number to the reply information to the client computer, and control is returned to step S32.

On the other hand, if there are no connection-permitted ports, the visualize request processing unit 16 adds the notification that there is no available port for the computer to the reply information to the client computer in step S34, and control is returned to step S32.

If it is determined in step S32 that the processes have been completed on all computers in the list, then the visualize request processing unit 16 determines in step S36 whether or not the reply information to the client computer is null, that is, whether or not a visualize request was issued before starting the computation.

If it is determined in step S36 that the reply information is null, then a reply information transmission unit 18 notifies the client computer (user) that the computation has not been started yet in step S38, thereby terminating the series of processes.

On the other hand, if it is determined that the reply information is not null, then the reply information transmission unit 18 transmits the reply information to which data is sequentially added in steps S34 and S35 to the client computer in step S37, thereby terminating the series of processes.

Described next is the second embodiment. In the second embodiment, a user performs a collective job through the client device (client computer) 4. The executing program provides the fourth interface for accessing the service published by the DB server device. The fourth interface outputs a part of the output data as a feature value to the DB server device at the end of the program. For example, when N feature values (integers) and M feature values (double-precision) are output, the following items are output to the DB server device.

Feature Value (integer) 1
Feature Value (integer) 2
...
Feature Value (integer) N
Feature Value (double-precision) 1
Feature Value (double-precision) 2
...
Feature Value (double-precision) M

Each time a single job belonging to a collective job is completed, each feature value of the single job is output to the DB server device. When all single jobs belonging to the collective job are completed, a statistical analysis is performed on the DB server device using each feature value of the single jobs belonging to the collective job.

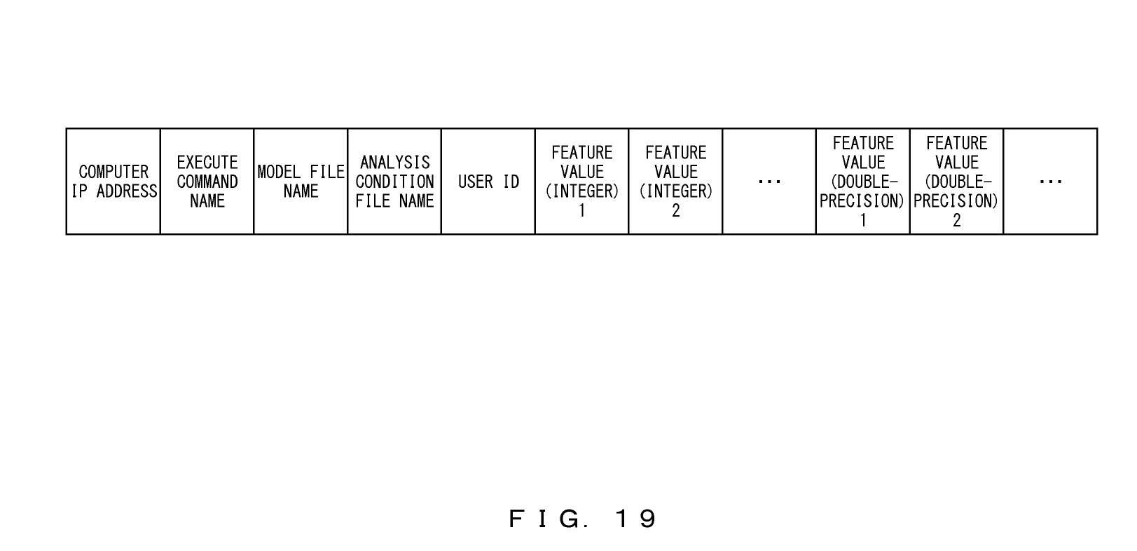

FIG. 19 illustrates the data structure of a feature value entry notification from a computer to a DB server device.

As illustrated in FIG. 19, a feature value entry notification includes the items of “(computer) IP address”, “execute command name”, “model file name”, “analysis condition file name”, “user ID”, “feature value (integer) 1”, “feature value (integer) 2”, . . . , “feature value (double-precision) 1”, “feature value (double-precision) 2”, . . . .

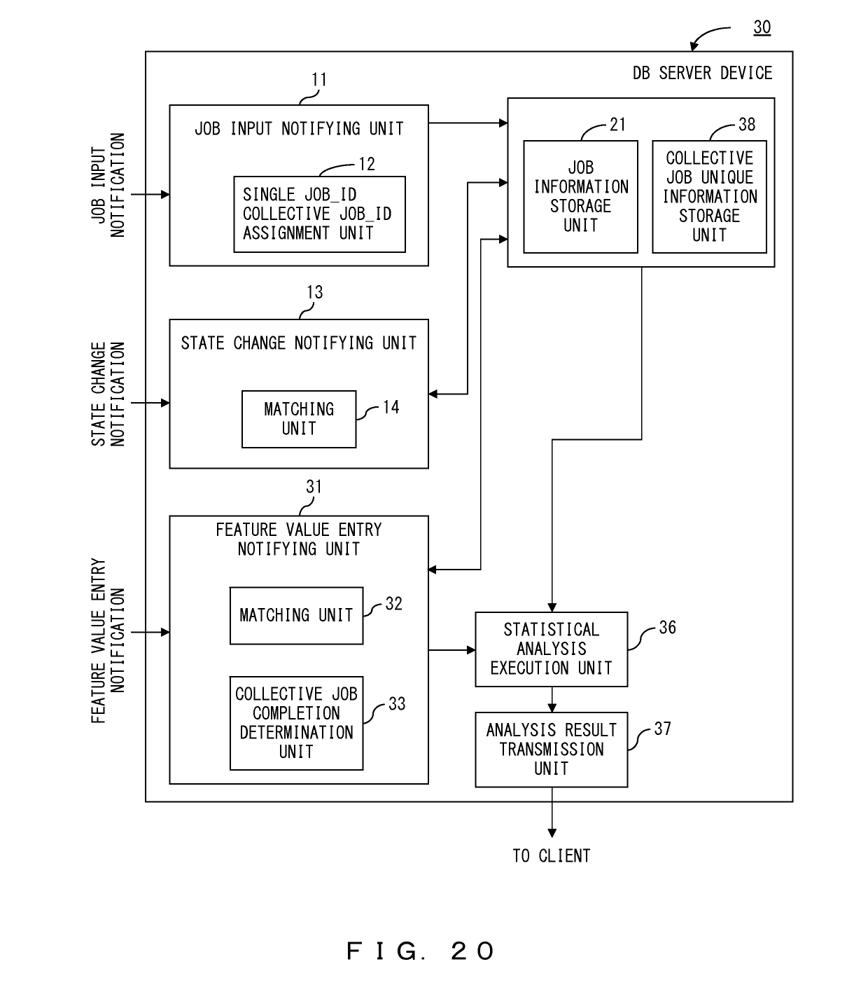

FIG. 20 is a block diagram of the configuration of the DB server device according to the second embodiment of the present invention.

As illustrated in FIG. 20, a DB server device 30 includes: a feature value entry notifying unit 31 for processing a feature value entry notification received from a computer; a statistical analysis execution unit 36 for performing a statistical analysis using each feature value of a single job belonging to a collective job when all single jobs belonging to the collective job are completed; an analysis result transmission unit 37 for transmitting an analysis result to a client device; and a collective job unique information storage unit 38 for storing unique information in a collective job.

The operations of the job input notifying unit 11 and the state change notifying unit 13, and the data structure of the job information storage unit 21 are the same as in the first embodiment, and the descriptions are omitted here.

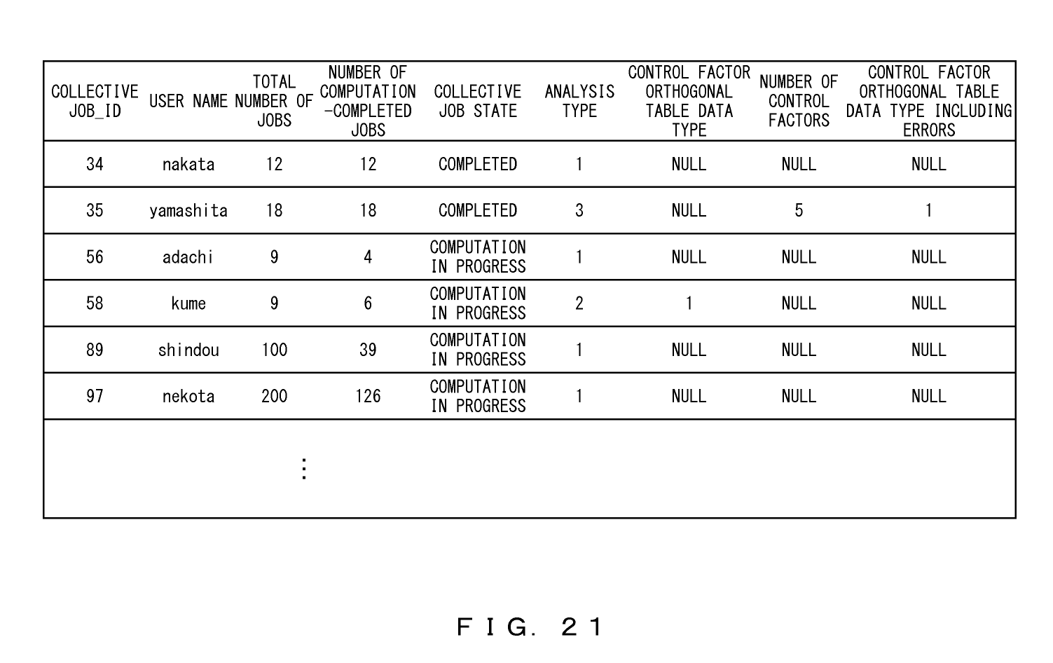

FIG. 21 illustrates the data structure of the collective job unique information storage unit collective job unique information storage unit 38 illustrated in FIG. 20.

As illustrated in FIG. 21, the job information storage unit 21 includes the items of “collective JOB_ID”, “user name”, “total number of jobs”, “number of computation-completed jobs”, “collective job state”, “analysis type”, “control factor orthogonal table type”, “number of control factors”, and “control factor orthogonal table type including errors”.

The “total number of jobs” indicates the number of single jobs included in a collective job. The “number of computation-completed jobs” indicates the number of single jobs for which the computation has been completed in the single jobs included in a collective job. The “collective job state” has the settings of “completed” if the computation has been completed for all single jobs included in a collective job, and “during computation” if the computation has not been completed in all single jobs included in a collective job.

The “analysis type” is flag information (for example, 1 indicates a statistical analysis, 2 indicates an analysis on the basis of an experiment planning method, and 3 for an analysis performed on the basis of quality engineering) for determining what evaluating method is to be adopted when a statistical analysis is performed using each feature value of a single job belonging to a collective job for which the computation of all single jobs has been completed. The “control factor orthogonal table type” includes a value significant when the value set in the “analysis type” is an “analysis on the basis of an experiment planning method”. The “number of control factors”, and the “control factor orthogonal table type including errors” have values significant when the value set in the “analysis type” is the “analysis on the basis of quality engineering”.

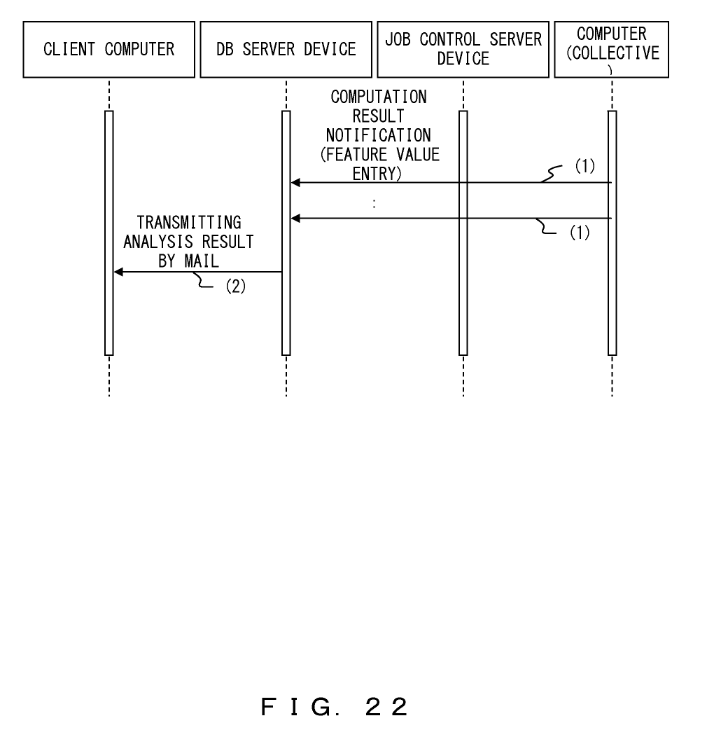

FIG. 22 is a chart of the sequence o the process after the completion of the computation according to the second embodiment.

In FIG. 22, first in (1), the computing program executed through a client computer currently logged in by a user or a client computer previously logged in by the user is terminated, and a computation result notification (feature value entry notification) is issued from the executing program on the computer to the DB server device.

The DB server device receives a feature value entry notification, associates (matches) the notification with a record in the job information storage unit 21, and writes a feature value to the related item of the record. It also determines on the collective job including the single job for which the computation has just been completed as to whether or not all single jobs in the collective job have been completed.

If it is determined that the computation of all single jobs included in the collective job has been completed, then a statistical analysis is performed using each feature value of the single jobs belonging to the collective job, and the analysis result is transmitted by email to the client computer in (2).

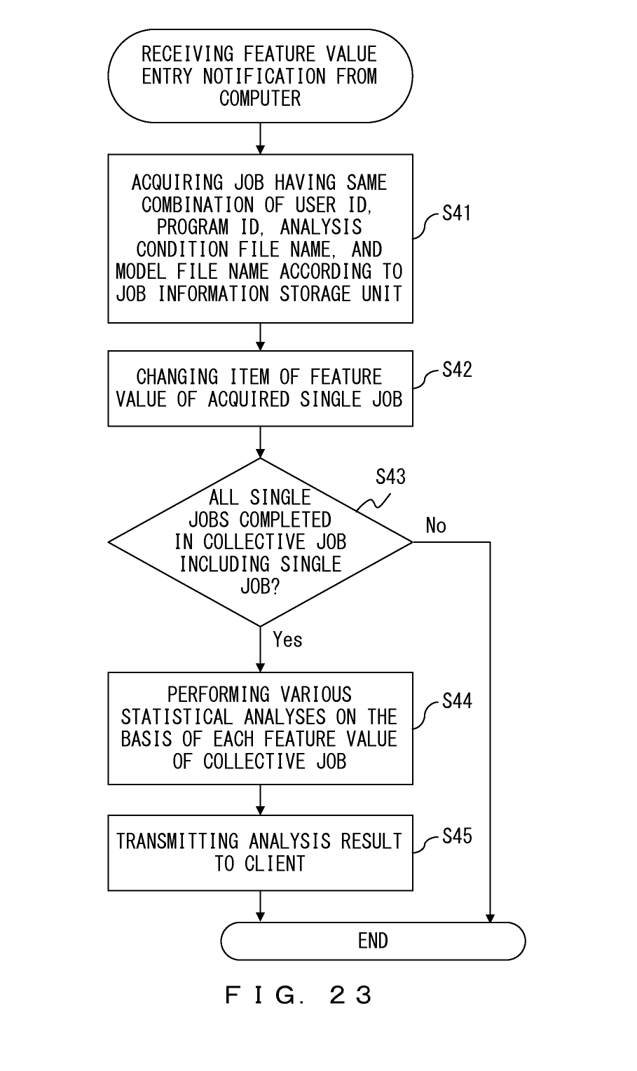

FIG. 23 is a flowchart of the feature value entry/statistical analysis executing process performed by the DB server device when a feature value entry notification is received according to the second embodiment.

In FIG. 23, first in step S41, the feature value entry notifying unit 31 illustrated in FIG. 20 associates (matches) a notification of a state change of the received feature value entry notification with the job information stored in the job information storage unit.

The feature value entry notification has the data structure as illustrated in FIG. 19. The feature value entry notifying unit 31 activates a matching unit 32 and searches the job information storage unit 21 to acquire a row (record) of the single job having the same combination of an execute command name, a model file name, an analysis condition file name, and a user ID as the received feature value entry notification.

The feature value entry notifying unit 31 changes the record by writing a value included in the feature value entry notification to the item of the feature value in the acquired record in step S42, and writes the changed record to the job information storage unit 21.

Then, in step S43, the feature value entry notifying unit 31 activates a collective job completion determination unit 33 and determines on the collective job including the single job processed in steps S41 and S42 as to whether or not the computation of all single jobs included in the collective job has been completed.

If it is determined in step S43 that the computation of all single jobs included in the collective job has not been completed, then the series of processes are terminated.

On the other hand, if it is determined in step S43 that the computation of all single jobs included in the collective job has been completed, then the feature value entry notifying unit 31 activates the statistical analysis execution unit 36 in step S44. The statistical analysis execution unit 36 reads the information about the analysis type etc., and performs the statistical analysis depending on the analysis type using each feature value of the single job belonging to the collective job. In step S45, the analysis result transmission unit 37 transmits an analysis result to the client computer (user), thereby terminating the series of processes.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has (have) been described in detail, it should be understood that the various changes, substitutions, and alterations could be made hereto without departing from the spirit and scope of the invention.

What is claimed is:

1. A computing job information managing device that manages computing job information using a computing job controller and a plurality of computers allocated computing jobs by the computing job controller, comprising:
an identification information assignment unit that assigns computing job identification information independent of the computing job controller to an input computing job upon receipt of a notification that a terminal has input the computing job to the computing job controller together with user identification information and identification information about a computation executing program from a terminal;
a computing job information storage unit that stores a record in which the computing job identification information is associated with the user identification information;
a matching unit that performs a matching process using user identification information and identification information about a computation executing program upon receipt of state change information about the computing job from a computer assigned a computing job together with user identification information and identification information about a computation executing program; and
a computing job identification information access control unit that writes received state change information to a related item of a record of the computing job information storage unit associated with the received state change information by the matching process.

2. The computing job information managing device according to claim 1, further comprising
a second identification information assignment unit that assigns computing job identification information independent of the computing job controller, and collective job identification information that identifies a collective job to a plurality of computing jobs belonging to an input collective job when a notification that the collective job including a plurality of computing jobs as a group has been input is received with user identification information and identification information about a program executing computation from a terminal.

3. The computing job information managing device according to claim 1, further comprising:
an available port determination unit that determines whether or not there is an available port for a computer executing computation upon receipt of a request to acquire in-progress data of the computation or data of a result of the computation; and
a computer information transmission unit that transmits to a terminal a combination of a computer that performs computation and the number of available ports when there are available ports.

4. The computing job information managing device according to claim 1, further comprising:
a second matching unit that performs a matching process using user identification information and identification information about a computation executing program upon receipt of a feature value as a part of data output by a computation executing program together with user identification information and identification information about a computation executing program as a feature value entry notification;
a second computing job identification information access control unit that writes a received feature value to a related item of a record of the computing job information storage unit associated with the received feature value by the matching process;
a collective job completion determination unit that determines whether or not all computing jobs belonging to a collective job have been completed when the feature value entry notification is issued from a computing job belonging to the collective job;
a statistical analysis execution unit that executes a statistical analysis using each feature value of a computing job belonging to the collective job when it is determined that all computing jobs belonging to the collective job have been completed; and
an analysis result transmission unit that transmits an analysis result to a terminal.

5. A terminal that performs a computing job using a computing job controller and a plurality of computers allocated a computing job from the computing job controller, comprising:
a computing job input unit that inputs a computing job to the computing job controller; and
a computing job input information notification unit that notifies a computing job management device that assigns computing job identification information independent of computing job identification information assigned by the computing job controller of the input of the computing job, wherein
when the computing job input unit is activated, the computing job input information notification unit is cooperatively activated.

6. The terminal according to claim 5, wherein
the computing job input information notification unit can specify for a plurality of input computing jobs whether or not the jobs are processed as a group.

7. A computing job information managing system that manages computing job information using a computing job controller and a plurality of computers allocated computing jobs by the computing job controller, comprising:
a terminal that inputs a computing job to the computing job controller; and
a computing job information managing device that assigns, to a computing job, computing job identification information independent of computing job identification information assigned by the computing job controller, wherein
when a computing job is input to the computing job controller, the terminal transmits user identification information and a notification of the input of the computing job having identification information about a program executing computation to the computing job information managing device;
a computer allocated a computing job notifies the computing job information managing device of a state change including the user identification information and the identification information about the program executing the computation when the computer detects the state change of the computing job;
upon receipt of the notification of the input of the computing job, the computing job information managing device assigns the computing job identification information independent of the computing job controller to the input computing job; and
when the notification of the state change from the computer allocated the computing job is received, a matching process is performed using the user identification information and the identification information about the program executing the computation, thereby writing information about the state change included in the notification of the state change to a related item of corresponding computing job identification information.

8. A computing job information managing method that manages computing job information using a computing job controller and a plurality of computers allocated computing jobs by the computing job controller, comprising:
transmitting, when a computing job is input from a terminal to the computing job controller, user identification information and a notification of the input of the computing job having identification information about a program executing computation to the computing job information managing device;
notifying the computing job information managing device of a state change by an allocated computing job, the state change including the user identification information and the identification information about the program executing the computation when the computer detects the state change of the computing job;
assigning the computing job identification information independent of the computing job controller to the input computing job upon receipt of the notification of the input of the computing job; and
performing a matching process using the user identification information and the identification information about the program executing the computation, when the notification of the state change from the computer allocated the computing job is received; and
writing information about the received state change to a related item of the computing job identification information associated with the information about the received state change by the matching process.
